(19) United States
(12) Patent Application Publication
(10) Pub. No.: US 2024/0095978 A1
(43) Pub. Date: Mar. 21, 2024

(54) HIGH SPATIOTEMPORAL FIDELITY MRI SYSTEM UTILIZING SELF-SUPERVISED LEARNING WITH SELF-SUPERVISED REGULARIZATION RECONSTRUCTION METHODOLOGY AND ASSOCIATED METHOD OF USE

(71) Applicant: THE CURATORS OF THE UNIVERSITY OF MISSOURI, Columbia, MO (US)

(72) Inventors: Changyu Sun, Columbia, MO (US); Talissa Ann Altes, Columbia, MO (US)

(21) Appl. No.: 18/472,077

(22) Filed: Sep. 21, 2023

Related U.S. Application Data
(60) Provisional application No. 63/376,529, filed on Sep. 21, 2022.

(51) Int. Cl. G06T 11/00; G06T 5/00

(52) U.S. Cl. CPC G06T 11/006; G06T 5/002; G06T 2207/10088; G06T 2207/20081; G06T 2207/20084; G06T 2207/20212; G06T 2207/30004; G06T 2210/41; G06T 2211/441

(57) ABSTRACT

A system and method to process images, for single band(SB) and multiband (MB) acceleration to improve the quality of MRI images, e.g., accelerating and reconstructing myocardial perfusion MRI acquisition, which includes an MRI, a processor, and a memory, enabled to store data in electronic communication with the processor, wherein the memory is able to receive image data of the MRI, and the processor is able to utilize a Self-LR model based on a physics guided Siamese network structure utilizing an encoding matrix with coil sensitivity maps and an undersampling mask that is converted to a first model deep learning block that communicates with a physics guided data augmentation followed by a re-undersampling block and then to a plurality of physics guided subnets. This is a self-supervised learning with self-supervised regularization reconstruction technique that utilizes all available data for training and improves spatiotemporal fidelity without reference data.

### CROSS REFERENCE TO RELATED APPLICATIONS

This application claims priority under 35 U.S.C. § 119 to provisional patent application U.S. Ser. No. 63/376,529, filed Sep. 21, 2022. The provisional patent application is herein incorporated by reference in its entirety, including, without limitation, the specification, claims, and abstract, as well as any figures, tables, appendices, or drawings thereof.

### TECHNICAL FIELD

The present disclosure relates generally to technology or accelerating MRI and reconstruction of the accelerated MRI data. This is the application of improvement of spatial resolution and slice coverage for perfusion MRI. However, this technology is for the acceleration and reconstruction of MRI without fully-sampled MRI data or any labels. This can include rapid MRI, which improves the efficiency of MRI imaging, and further provides high spatial and temporal resolution imaging and high slice coverage.

### BACKGROUND

The background description provided herein gives context for the present disclosure. Work of the presently named inventors, as well as aspects of the description that may not otherwise qualify as prior art at the time of filing, are neither expressly nor impliedly admitted as prior art.

Ischemic heart disease is a leading cause of death in the US. Angina, or ischemic chest pain, was historically thought to result from obstructive coronary artery disease (CAD). There is now an increasing recognition that coronary microvascular disease (CMD) is a clinically significant cause of angina in patients with nonobstructive coronary artery disease. CMD is associated with an increased risk of major adverse cardiac events. More importantly, the limited spatial resolution and slice coverage of routine DCE imaging may be unable to distinguish endocardial and epicardial while missing abnormalities at unacquired locations and severely limiting deeper insight into ischemic myocardial disease.

Despite tremendous advances in developing accelerated methods for increasing spatial resolution and slice coverage, current reconstruction frameworks may fail to reconcile high acceleration rates with high image fidelity. Most highly accelerated MRI reconstruction frameworks suffer from aliasing and blurring artifacts and may require a long reconstruction time, over sixty minutes, and time-consuming analysis. Deep convolutional neural network methods have gained interest for accelerating and reconstructing MRI for other body parts using fully sampled MRI data as training data. As it is impossible to acquire a fully sampled dataset in a limited time with contrast infusion in the beating heart, improving imaging with supervised learning is a challenge. The rising trend of physics-guided self-supervised learning, which utilizes prior physical knowledge, encounters challenges from training instability and noise enhancement due to a lack of fully sampled data. Asymmetric echo and varied image sizes are routinely used, which can challenge methods like self-supervised learning via data undersampling (SSDU).

The standard physics-guided unrolled network suffers from noise or inability to use all available training data, and a significant disadvantage of high spatiotemporal resolution myocardial DCE MRI is the limited slice coverage compared to other imaging modalities. Highly accelerated first-pass myocardial MRI is useful for improving the assessment of coronary artery disease; however, a tradeoff exists among SNR, spatial and temporal fidelity for parallel imaging, and compressed sensing-based reconstruction methods.

Thus, there exists a need in the art for an MRI system that provides a high-quality reconstruction methodology without the need for fully sampled data, as a reference, such that spatiotemporal fidelity is improved.

### SUMMARY

The following objects, features, advantages, aspects, and/or embodiments, are not exhaustive and do not limit the overall disclosure. No single embodiment needs to provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

An aspect of the present disclosure is a system for accelerating and reconstruction of MRI without any ground truths. For example, it is used for accelerating perfusion MRI and improving the resolution and slice coverage, and it shows potential application for the detection of CMD or CAD. This includes processing MRI images that include an MRI, a processor, and a memory, enabled to store data in electronic communication with the processor, wherein the memory is able to receive image data of a dynamic scene from the MRI, and the processor is able to utilize a Self-LR model based on a Siamese network structure utilizing an encoding matrix with coil sensitivity maps and an undersampling mask that is converted to an intermediate fully sampled model deep learning that is then passed into a re-undersampling process and then reconstructed into unsampled k-space through a second model deep learning process.

Another aspect of the present disclosure is a denoise block to control noise from undersampling with or without denoising networks like Unet operating on the unsampled k-space through a second model deep learning process.

Yet another aspect of the present disclosure is both a stop-gradient and an additional learning network, e.g., Unet. Unet is only one illustrative example, with numerous other networks that can be utilized. Noise is a significant factor in the selection of the network.

Another feature of the present disclosure is the process utilizes deep learning priors.

Yet another aspect of the present disclosure is the deep learning priors, include MoDL (model-based deep learning architecture) that uses a ResNet structure with a predetermined number of residual blocks and is unrolled for a predetermined number of iterations. This is for illustrative purposes only since it could be other networks, with the important aspect being the physics coils information and not any one specific network.

Another feature of the present disclosure is the re-undersampling includes an intermediate multicoil k-space followed by random undersampling that utilizes a design comparable to the original undersampling mask followed by generating a coil combined image.

Still another aspect of the present disclosure is the first model deep learning block, the second model deep learning block, and the third model deep learning block includes a series of iterations, each including an unrolled network including data consistency block and a ResNet for deep residual learning for image reconstruction followed by data consistency analysis. Three networks are merely an example, with more subnetworks capable of being used.

Still, yet another feature of the present disclosure is a system to process MRI images for single band and/or multiband acceleration, to improve the quality of coronary artery disease that includes an MRI, a processor, and a memory, enabled to store data in electronic communication with the processor, wherein the memory is able to receive image data of a dynamic scene from the MRI, and the processor is able to utilize a Self-LR model based on a Siamese network structure utilizing an encoding matrix with coil sensitivity maps and an undersampling mask that is converted to a first model deep learning block that communicates with a physics guided data augmentation followed by a re-undersampling block and then to a plurality of physics guided subnets.

A further disclosure feature is a physics-guided network that may be useful with a standard stop-gradient. A physics-guided Siamese network can be improved by stop-gradient to avoid collapsing.

Still, another feature of the present disclosure is the plurality of physics-guided subnets includes one block with backpropagation, and the remainder of physics-guided subnets include a stop-gradient with shared weights with only one subnet updating weights during backpropagation and the other subnets using stop-gradient to prevent collapsing.

Still yet another feature of the present disclosure is the physics-guided subnet that includes one block with backpropagation includes a second model deep learning block connected to a denoise block. An important aspect is the concept of utilizing physics-guided data augmentation and physics-guided subnetworks consistency.

Another aspect of the present disclosure is the plurality of physics-guided subnets with stop gradient, includes a third model deep learning block connected to a denoise block.

It is still another feature of the method of the present disclosure is the Self-LR model provides a physics-guided Siamese network, which includes physics-guided data augmentation, and a physics-guided network consistency concept that is included in a loss function.

It is yet another feature of the method of the present disclosure for processing images that are single and/or multiband, to improve the assessment, which includes utilizing a processor in electronic communication with a memory, wherein the memory is able to receive image data of a dynamic scene from an MRI, and utilizing the processor with a Self-LR model based on a Siamese network structure utilizing an encoding matrix with coil sensitivity maps and an undersampling mask that is converted to a first model deep learning block that communicates with a physics-guided data augmentation followed by a re-undersampling block and then to a plurality of physics guided subnets.

Still yet another aspect of the present invention is the first model deep learning block, the second model deep learning block, and the third model deep learning block includes a series of iterations, each including ResNet for deep residual learning for image reconstruction followed by data consistency analysis.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated.

FIG. 1 shows a basic schematic layout of an MRI imaging system and control unit.

FIG. 2 is a schematic block diagram of a Self-LR model associated with the present disclosure.

FIG. 3 is a schematic block diagram of the Model-based Deep Learning (MoDL Block) from FIG. 2

FIG. 4 is a schematic block diagram of the Re-undersampling function from FIG. 2.

FIG. 5 is a schematic diagram of self-supervised learning with self-supervised regularization network structure (Self-LR) and loss function for SB data.

FIG. 6 is a schematic block diagram of the Model-based Deep Learning (MoDL Block) and a Re-undersampling block from FIG. 5.

FIG. 7 is a schematic block diagram of a multiband (MB) loss function associated with self-supervised learning with self-supervised regularization network structure (Self-LR) associated with FIG. 5,

FIG. 8 is a comparison of rate-8 ESPIRiT, low rank plus sparse (L+S), and Self-LR reconstructed images to reference rate-2 GRAPPA images at different time points of a mid-ventricular slice.

FIG. 9 shows graphs of intensity-time signal curves of ESPIRiT, L+S, and Self-LR at the myocardial region of three slices of a patient are shown.

FIGS. 10A, 10B and 10C shows three slices simultaneously acquired are shown in time-intensity curves showing slice-Self-LR has improved SNR and temporal fidelity compared to slice-L+S.

FIG. 11 is a comparison of slice-GRAPPA, slice-L+S, and slice-Self-LR for the reconstruction of MB=3 and R=3 with 1.5 millimeters×1.5 millimeters resolution and nine slices dataset prospectively acquired from a patient. Here, three slices simultaneously acquired are shown. Slice-Self-LR shows improved SNR and temporal fidelity compared to slice-L+S.

FIG. 12 is aa nine slices reconstruction of an MB=3 and R=3 with 1.5 milimeters×1.5 millimeters resolution, which shows good image quality and SNR for all slices.

FIG. 13 is an overview schematic of a self-LR design associated with the present disclosure.

FIG. 14 is a schematic overview of self-LR design.

FIGS. 15A and B are a schematic diagram of the comparison between self-supervised learning with self-supervised regularization network structure (self-LR) and self-supervised learning via data undersampling (SSDU) using over an 11-fold acceleration with asymmetric echo.

FIGS. 16A and B is a comparison of zero-padding, CG-SENSE, SSDU, and self-LR methods in the reconstruction of prospectively undersampled MB first-pass perfusion MRI (R=11.4) with a spatial resolution of 1.5 millimeters×1.5 millimeters, temporal resolution of 95 ms, and 8-slice coverage of the left ventricle and a comparison of all acquired slices using zero-padding, CG-SENSE, SSDU, and self-LR for the reconstruction of prospectively undersampled first-pass perfusion MRI, respectively.

FIGS. 17A and B are three additional patient examples from the test datasets (excluding the patient in FIG. 16, illustrating the self-LR reconstruction across the entire field-of-view for all seven slices at a single measurement and a clinical reader's image assessment results for the highly accelerated perfusion MRI are summarized in the bar plots, which depict the average reader scores and corresponding standard deviations across all five test subjects, slices, and measurements, respectively.

An artisan of ordinary skill in the art need not view, within isolated figure(s), the near-infinite distinct combinations of features described in the following detailed description to facilitate an understanding of the present disclosure.

### DETAILED DESCRIPTION

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

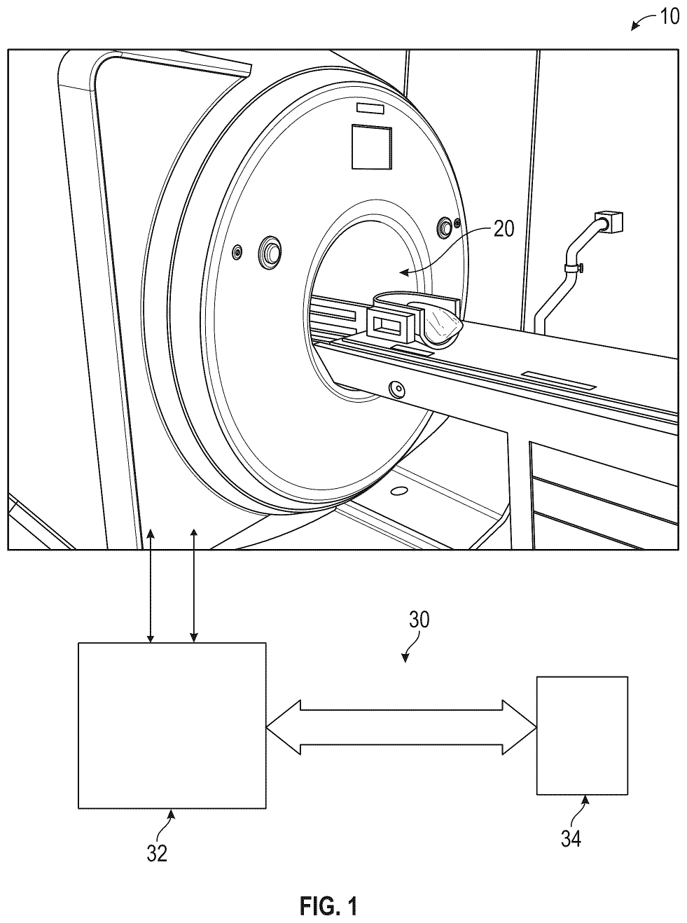

Referring now to FIG. 1, a basic MRI imaging system is generally indicated by the numeral 10 and includes a platform 20 in electrical communication with a control unit 30. The control unit 30 includes at least one processor 32 in electronic communication with at least one memory 34. An illustrative, but nonlimiting, example of an MRI is a SIEMENS® AERA 1.5 T that includes a redesigned total imaging matrix (TIM) platform known as “TIM 4G”. In this case, 4G refers to the added coil elements and SNR that result from DirectRF technology. SIEMENS® is a federally registered trademark of Siemens Aktiengesellschaft Corporation, having a place of business at Werner-von-Siemens-Str.1, Munchen Federal Republic of Germany 80333.

One illustrative, but nonlimiting, example of this system 10 uses 20-34 RF receiver channels. Twenty-two datasets with three slices were acquired by the controller 30 using routine saturation-recovery gradient-echo sequence with rate-2 undersampling and reconstructed using GRAPPA. Synthetic rate-8 undersampling data were generated with a 24-lines calibration region. Generalized Autocalibrating Partially Parallel Acquisition (GRAPPA) is a parallel imaging technique to speed up MRI pulse sequences. The Fourier plane of the image is reconstructed from the frequency signals of each coil (reconstruction in the frequency domain).

The methodology is self-supervised data consistency loss and physics-based Regularization (Self-LR) with a Siamese network structure with a stop-gradient, and an additional Unet were trained without fully sampled datasets and constraints along the temporal dimension. Unet is a convolutional neural network that was developed for biomedical image segmentation. The SSR term is formulated by a re-undersampling block and the consistency of two physics-guided convolutional neural networks (CNNs). Ten datasets (1200 images), two datasets (240 images), and ten datasets (1200 images) were used as training, validation, and testing datasets. Synthetic rate-8 k-t undersampled datasets were generated and reconstructed using ESPIRiT and L+S methods. Rate-8 ESPIRiT, L+S, and Self-LR were compared to rate-2 GRAPPA reconstructed images using normalized root mean square error (nRMSE), the structural similarity index (SSIM) of the images, and normalized root mean squared error (nRMSE) of intensity-time curves to quantify spatial and temporal fidelity.

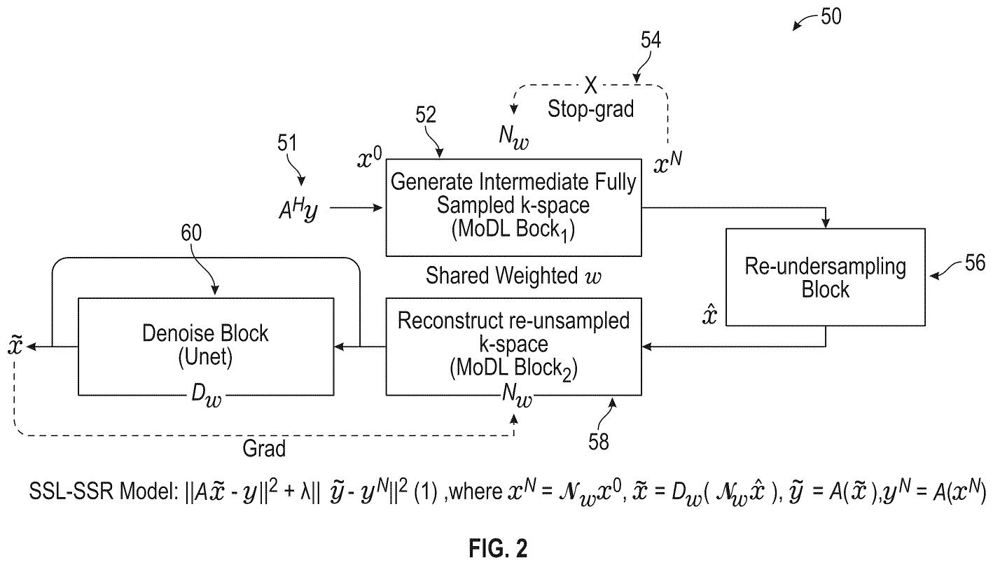

Referring now to FIG. 2, a schematic diagram of the proposed self-supervised learning with the self-supervised regularization model (Self-LR) is generally indicated by the numeral 50.

The inputs of network 50 are coil sensitivity maps, a 2D undersampling mask, and undersampled k-space data. The loss is defined as normalized l₁-l₂ loss of k-space data and normalized l₂ loss of k-space data. The loss can be l₁, l₂, l₁-l₂, SSIM loss, and so forth.

The network is trained using a learning rate of 5e-5 over 65 epochs with a batch size of 1.

A is the encoding matrix with coil sensitivity maps and an undersampling mask.

y is the acquired and understampled two-dimensional k-space data.
λ is a weighting parameter, which tradeoffs between data consistency loss and self-supervised regularization loss, where, in this instance, it is set to 0.2. [symbol]
_{ω} is a model-based reconstruction using deep learning priors. This can be any type of physics-guided unrolled network with MoDL (model-based deep learning architecture) block as only an illustrative but nonlimiting example.
x^{N} is the output image of the first (MoDL) block and thus the finally recovered image.
\tilde{x} is the output image of the second MoDL block and [symbol] Uₙₑₜ
\ddot{x} is the input of the second MoDL block and the output of the re-sampling block. [symbol]
generates a random re-undersampling mask that is generated on the fly, which is similar to the true mask.

Referring again to FIG. 2, a schematic diagram of the proposed self-supervised learning with a self-supervised regularization model (Self-LR) is generally indicated by the numeral 50.

MoDL is only one illustrative model-based deep learning architecture that can be utilized with the present invention. Other examples include, but are not limited to, MRM, 2018, 79: 3055-3071; Aggarwal et al. TMI, 2019, 38: 394-405; ResNet, and. Duan et al. MICCAI, 2019.

Coil sensitivity maps and an undersampling mask based on the acquired and understampled two-dimensional k-space data is indicated by numeral 51 and utilized to generate intermediate fully sampled k-space (MoDL Block1.) indicated by numeral 52.

The output image of the first (MoDL) block is utilized to create a model-based reconstruction using deep leaned priors (MoDL) (model-based deep learning architecture) block indicated by numeral 54 provided as input to step 52. The next step following step 52 is a re-undersampling block 56.

After step 56, the input of the second MoDL block and output of the re-sampling block are provided in step 58 of reconstructing the re-unsampled k-space (MoDL₂). This is followed by step 60, which is a denoise block (Unet) to create an output image of the second MoDL block and [symbol] Uₙₑₜ. that is also fed back to the model-based reconstruction using deep learned priors (MoDL) (model-based deep learning architecture) block 58. There is a shared weighting between steps 52 and 58.

The Self-LR model is as follows:

∥A\tilde{x}y∥²+λ∥\tilde{y}−y^{N}∥², where x^{N}= [symbol] _{ω}x⁰,\tilde{x}= [symbol] ( [symbol] _{ω},\hat{x}),\tilde{y}=A(\tilde{x}),y^{N}=A(\tilde{x}),y^{N}=A(x^{N}) Equation 1

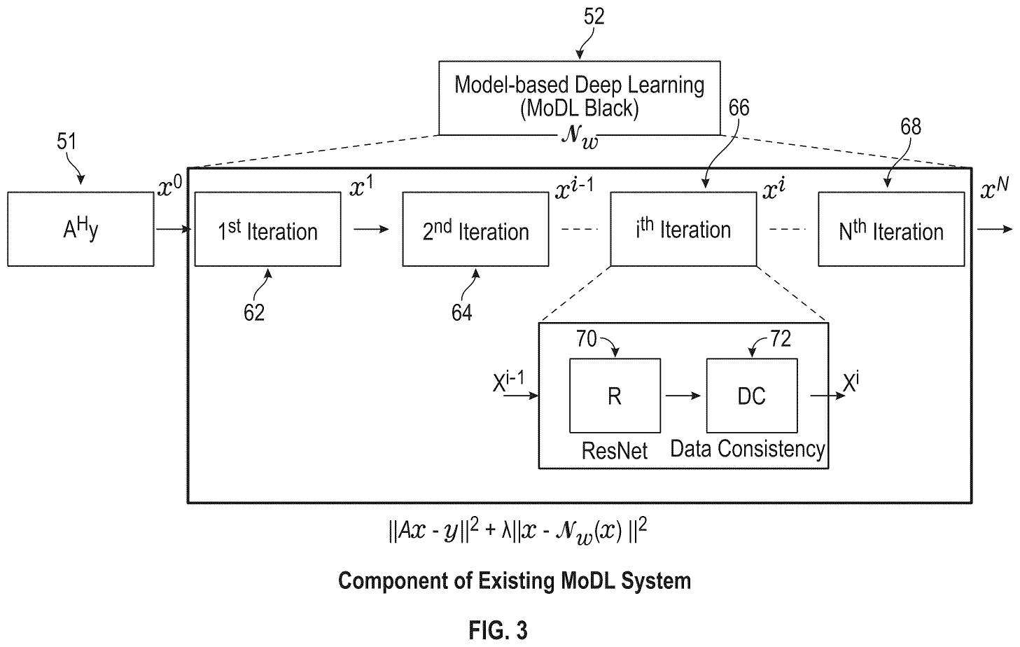

Further details of step 52 of the coil sensitivity maps and an undersampling mask based on the acquired and understampled two-dimensional k-space data are utilized to generate intermediate fully sampled k-space (MoDL Block₁) as shown in FIG. 3. The coil sensitivity maps and an undersampling mask based on the acquired and understampled two-dimensional k-space data pass through a first iteration 62, a second iteration 64, an i^{th} iteration 66 until an N^{th} iteration 68. The output is the output image of the first (MoDL) block and, thus, the finally recovered image. Each iteration 62, 64, 66, and 68 involves the use of ResNet, which is a deep learning model in which the weight layers learn residual functions with reference to the layer inputs 70, followed by data consistency analysis 72.

The model is as follows:

∥Ax−y∥²+λ∥x− [symbol] _{ω}(x)∥² Equation 2

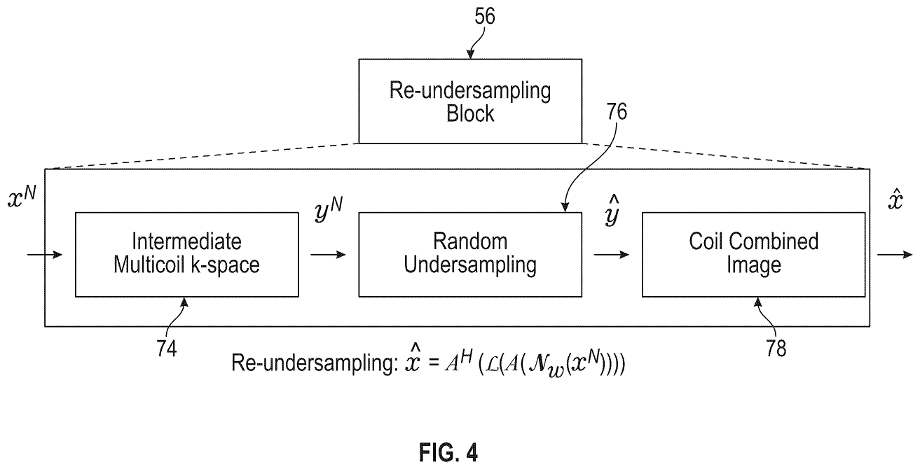

Further details of the re-undersampling block 56 are shown in FIG. 4. This includes inputting the output image of the first (MoDL) block into an intermediate multicoil k-space 74 that is then the acquired and undersampled two-dimensional k-space data that undergoes random undersampling 76 to generate an output image that is converted to a coil contained image 78 that provides the input to the second MoDL block and [symbol] Uₙₑₜ.

This re-undersampling is defined as follows:

\hat{x}=A^{H}( [symbol] (A( [symbol] _{ω}(x^{N})))) Equation 3

Therefore, the pipeline of the Self-LR model based on Siamese network structure using stop-gradient, where Unet serves as an additional denoise block to control the noise from re-undersampling, with model-based reconstruction using deep learning priors (MoDL shown in Equation.2, which uses ResNet structure with fifteen residual blocks and unrolled for ten iterations. The proposed re-undersampling block (shown in Equation 2) re-undersamples the k-space recovered from the first physics-guided MoDL block.

Equation 1 is the SSR-SSL loss function, which enforces the data consistency between the reconstructed k-space after the second MoDL and Unet and the undersampled k-space. The second term is a self-supervised regularization term, which enforces the recovered k-space from the first MoDL block and the reconstructed k-space from the second MoDL block, followed by Unet. The self-supervised Regularization enforces the consistency between the two physics-guided CNN blocks, which generates a trainable regularization.

Although this patent application uses myocardial perfusion MRI images, this is only an illustrative, but nonlimiting example with any types of MRI images capable of being utilized by this technology. An adaption of this same technology is self-supervised learning with self-supervised regularization reconstruction for accelerated single band and multiband myocardial perfusion. MRI. This can accelerate multiple MRI sequences without fully sampled datasets based on deep learning and multiband methods. This methodology includes a physics-guided (PG) self-supervised learning (SSL) method with self-supervised Regularization (Self-LR) using a Siamese structure for utilizing all the acquired k-space data in both data consistency block and calculation of loss function. To overcome the challenges of noise enhancement and collapsing, this Self-LR method was developed with a stop-gradient, a physics-guided (PG) data augmentation network block, and consistency of sub-Physics-guided networks. Therefore, the Self-LR method can be applied to both imaging for single-band (SB) and multiband (MB) acceleration. A wide variety of model deep learning tools can be utilized with this physics-guided (PG), recovering the data and providing input to different learning networks. Only current information is utilized rather than relying on repetition and borrowing other information.

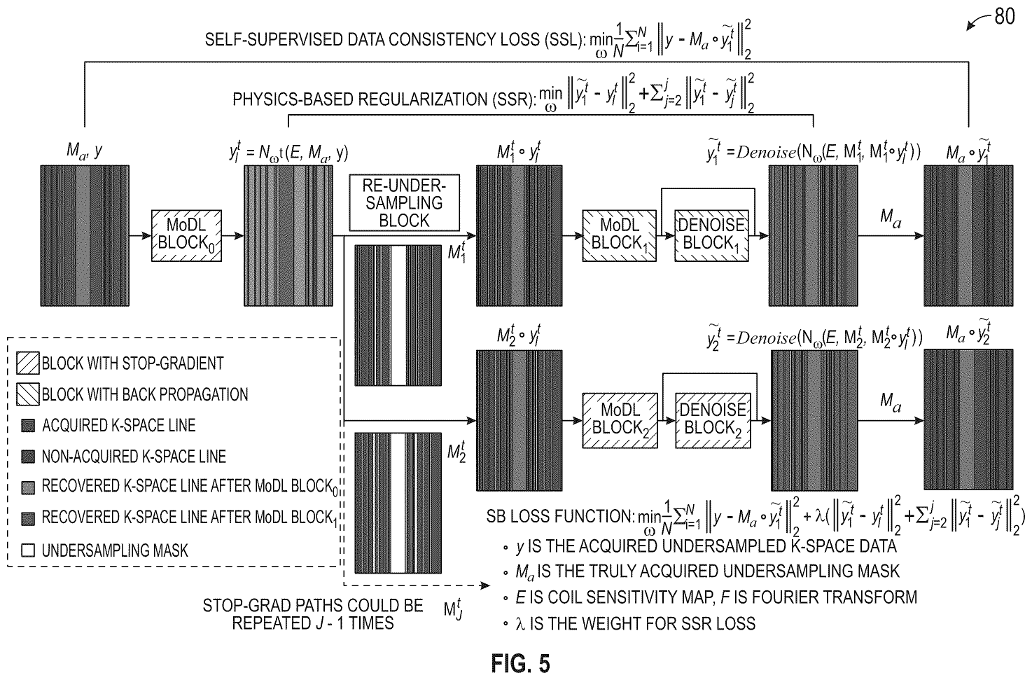

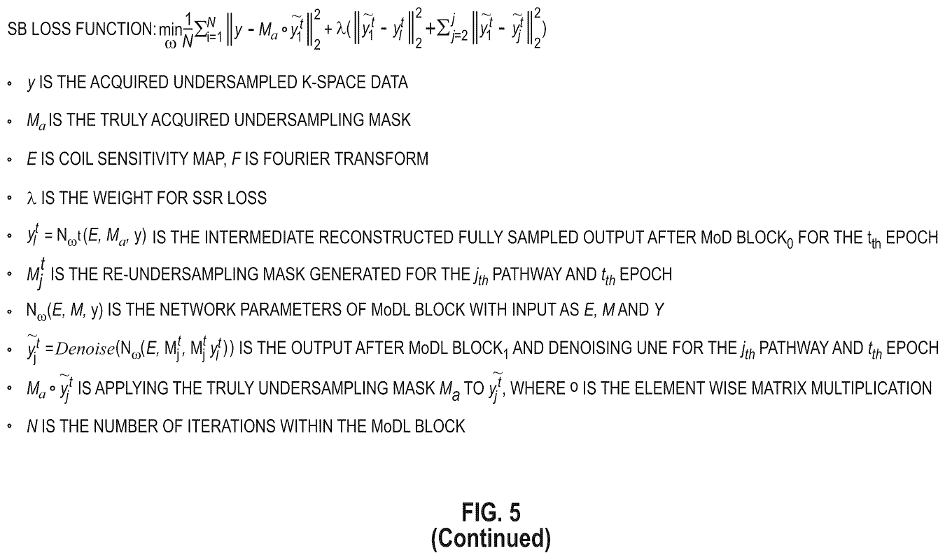

Referring now to FIG. 5, both single band and multiband data reconstruction is shown and generally indicated by numeral 80. Self-LR is designed based on 2D physics-guided-Siamese networks, which is composed of two or more identical sub-networks with shared weights. Only one sub-network will update weights during backpropagation, with other networks using stop-gradient to prevent collapsing.

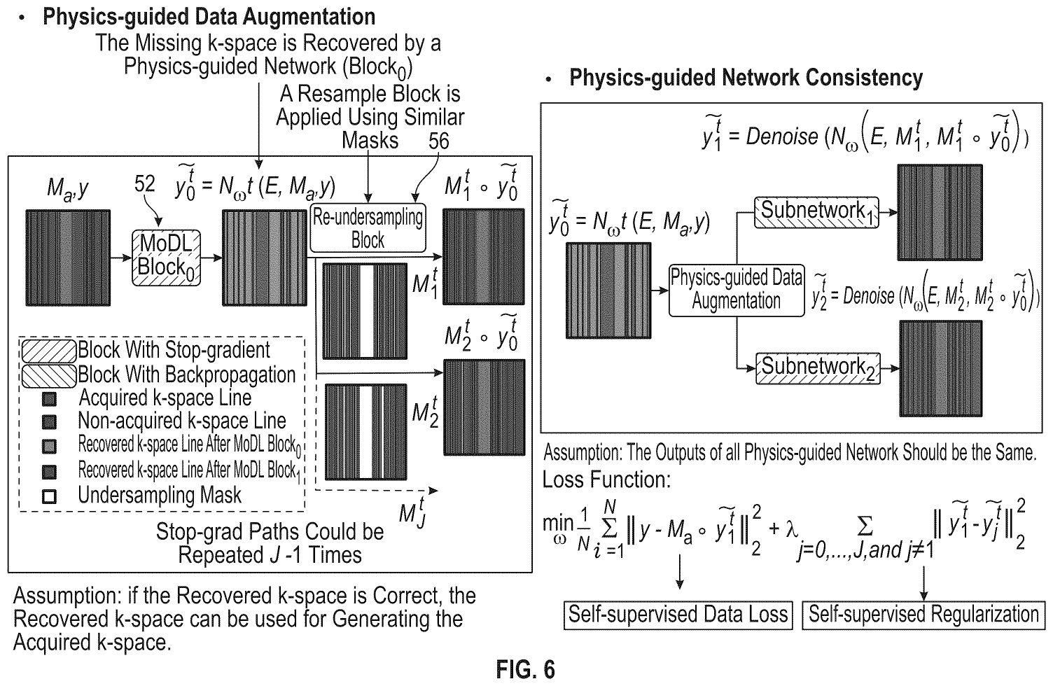

There is a Sub-Model-based deep learning block (sub-MoDL): MoDL is physics-based unrolled networks with N iterations to reconstruct undersampled images and act as the sub-network or subnet structure in Siamese architecture, which is also shown in FIG. 3 by numeral 52 as well as FIG. 6. The Siamese networks with stop-gradient represents an alternative algorithm between sub-networks, which formulates a new loss function between two or more augmentations of the same k-space.

The re-undersampling block is also previously shown in FIG. 4 by numeral 56 as well as FIG. 6. Based on calibration consistency, the Physics-guided-data augmentation method was developed. To enforce the subnetwork to solve a similar problem and use different data in DC blocks and the loss function, a new random re-undersampling mask M₁ generated by the Re undersampling block in each epoch t was applied to yᵢ to produce augmented undersampled data.

An additional Unet was used after MoDL blocks (j>0) to control the noise of images reconstructed using re-undersampled data, as also shown by numeral 60 as the denoise block in FIG. 1.

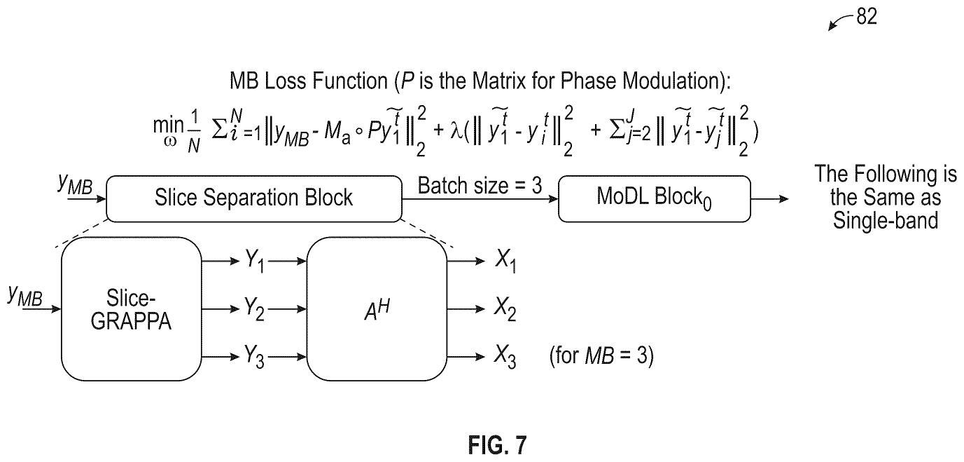

Referring now to FIG. 7, the multiband MB loss function is shown and generally indicated by the numeral 82. This includes self-supervised data consistency term is defined by the acquired data y and the final output Mₐ∘ŷ₁, which enables all acquired data to be utilized in both the loss function and DC blocks inside the network by means of Re-undersampling block and stop-gradient, and the physics-based regularization term among the outputs of the Siamese networks, which enforces the consistency among Physics-guided networks based on coil information and denoising of the networks.

The methodology includes twenty-two SB datasets 2640 images) with 2 25 millimeters×2.25-millimeter resolution were acquired using routine saturation recovery gradient echo sequence on 1 5 T system SIEMENS® AERA™) with rate 2 undersampling and reconstructed using GRAPPA Retrospective rate 8 undersampling data were generated with a twenty-four lines calibration region and reconstructed using ESPIRIT and L+S methods. There are ten datasets for training, two datasets for validation, and ten datasets for testing.

There are seven multiband (MB) datasets (2240 images) that were prospectively acquired with 1.5 millimeters×1.5-millimeters resolution MB images were reconstructed using slice GRAPPA and slice-L+S′ with four datasets for training and three for testing.

For the ten-testing dataset, RMSE values of the heart regions were 0.067±0.015, 0.045±0.012 and 0.041±0.010.SSIM values were 0.73±0.05, 0.81±0.07 and 0.85±0.05. RMSE of intensity-time signal were 0.98±0.51,0.75±0.35 and 0.47±0.28(*1e-3). Compared with rate-2 GRAPPA images, Self-LR shows significantly higher temporal fidelity with the lowest RMSE of the time signal and slightly higher image quality with the highest SSIM and lowest RMSE.

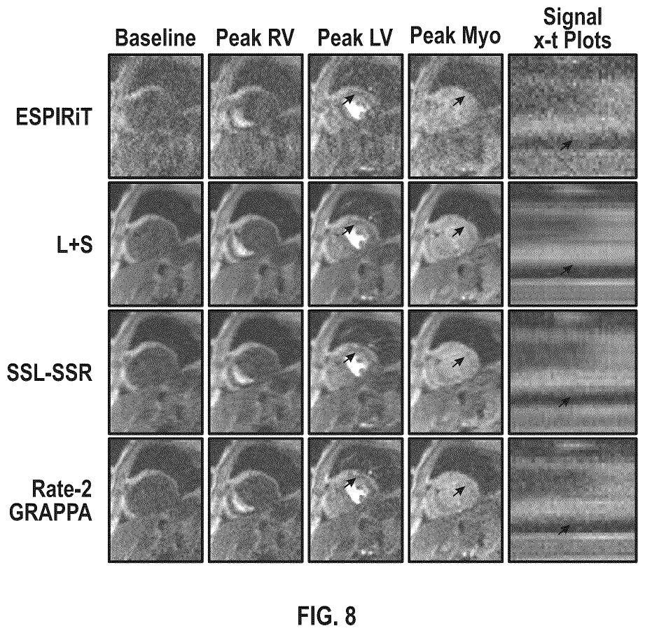

Referring now to FIG. 8 illustrates example images at different time points and signal x-t plots from one patient, where rate-8 ESPIRiT, L+S, Self-LR, and reference rate-2 GRAPPA images at a mid-ventricular location are shown. Self-LR shows higher image quality and is more similar temporal fidelity to reference images than ESPIRiT and L+S. Therefore, this is a comparison of rate-8 ESPIRiT, low rank plus sparse (L+S), and Self-LR reconstructed images to reference rate-2 GRAPPA images at different time points of a mid-ventricular slice. Red arrows indicate the difference in spatiotemporal fidelity of reconstruction methods. Self-LR outperforms ESPIRiT at all time points with significantly improved SNR. Self-LR (SSIM=0.9, RMSE=0.034) shows a slightly better reduction of image artifacts than L+S (SSIM=0.89, RMSE=0.038). However, using the self-supervised learned Regularization, Self-LR without temporal constraint shows more image details indicated by red arrows and higher temporal fidelity shown in signal x-t plots than L+S with temporal constraints. Self-supervised learning regularization effectively improves SNR and spatiotemporal fidelity compared to ESPIRiT, L+S, and rate-2 GRAPPA. Abbreviations: SNR, signal-to-noise ratio; LV, left ventricular; RV, right ventricular; and Myo, myocardial.

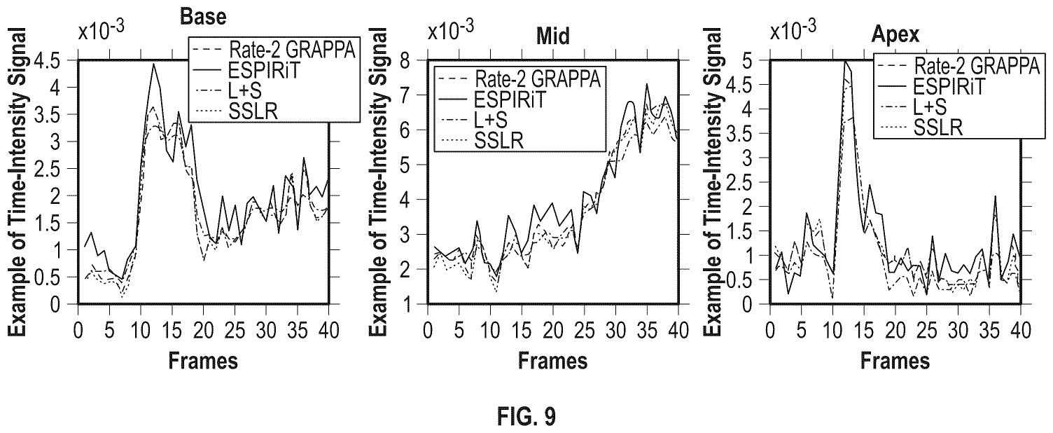

Referring now to FIG. 9, the intensity-time signal curves of ESPIRiT, L+S, and Self-LR at the myocardial region of three slices of a patient are shown, i.e., base, mid, and apex. Self-LR outperforms ESPIRiT at different time points with a significantly improved signal-to-noise ratio (SNR). Self-LR shows a slightly better reduction of image artifacts than L+S. However, using the self-supervised learned Regularization, Self-LR without temporal constraint shows more image details (red arrows) and higher temporal fidelity in signal x-t plots than L+5 with temporal constraints.

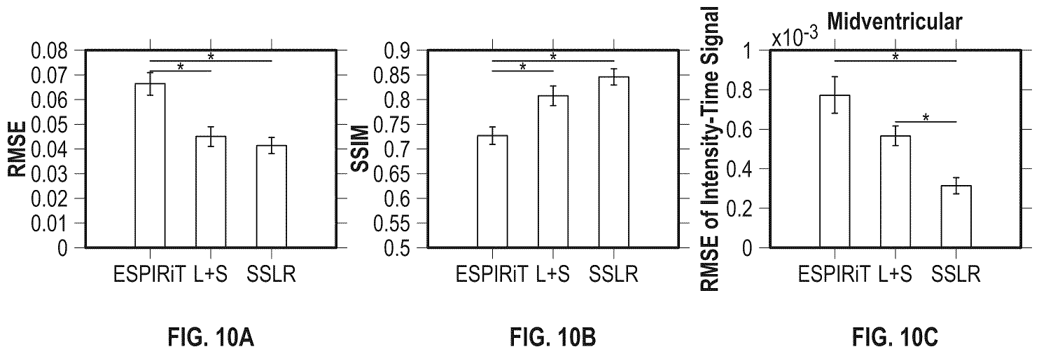

Referring now to FIG. 10, the RMSE of the heart regions was highest for ESPIRiT, intermediate for L+S, and slightly lower for Self-LR. This is indicated by Graph 10A. The SSIM of the heart regions was lowest for ESPIRiT, intermediate for L+S, and slightly higher for Self-LR. Self-LR shows the highest temporal fidelity, with ESPIRiT and L+S demonstrating low SNR and temporal blur, respectively, as indicated by Graph 10B. Finally, the RMSE of intensity-time signal for 10 datasets at the mid-ventricular location was highest for ESPIRiT, intermediate for L+S, and lowest for Self-LR (*P<0.05, ANOVA) in Graph 10C. Error bars indicate standard error. Self-LR improves spatiotemporal fidelity compared to parallel imaging and compressed sensing methods.

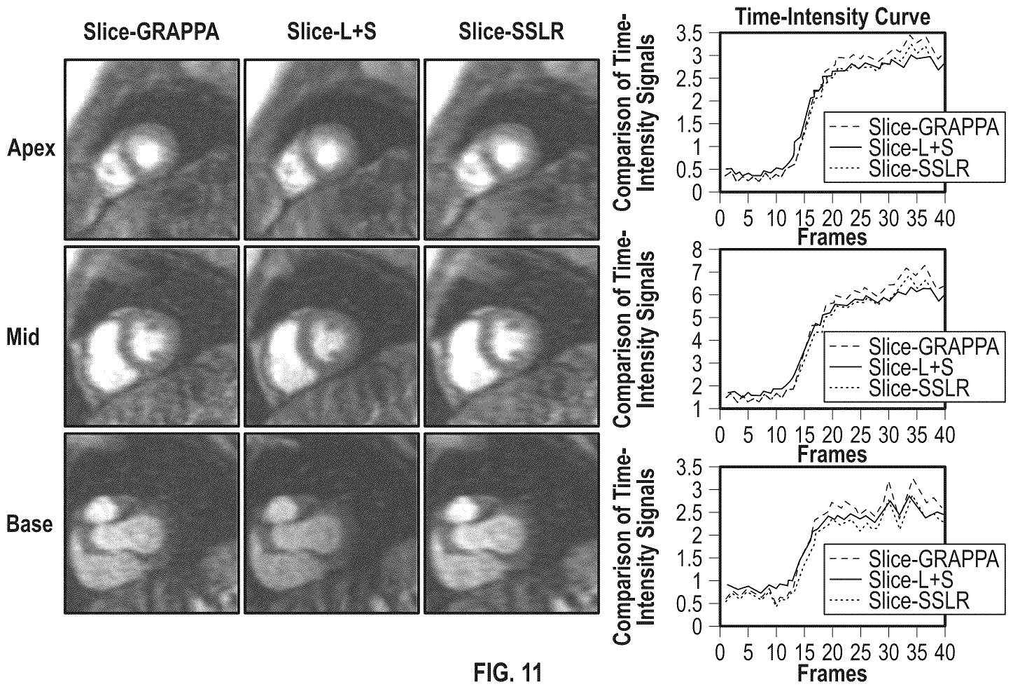

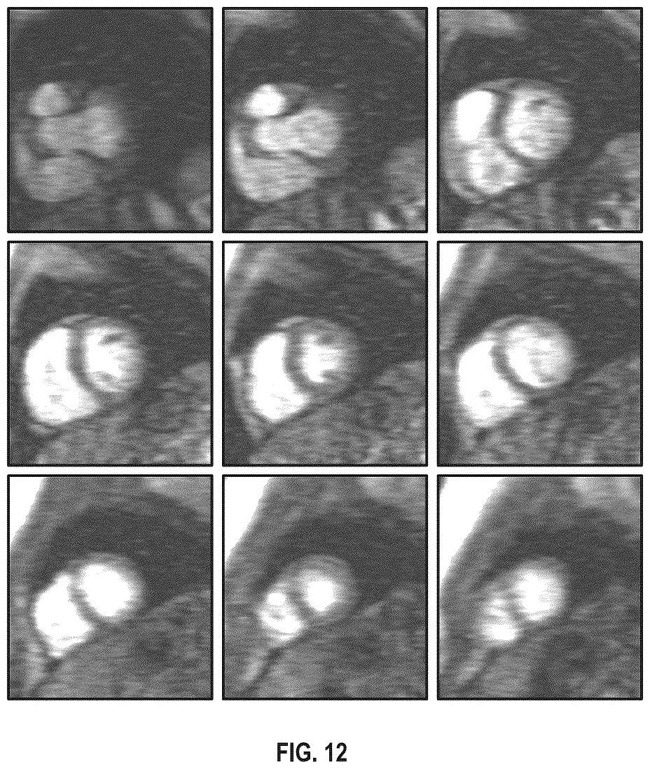

Referring now to FIG. 11 shows a comparison of slice GRAPPA, slice L+S, and slice Self-LR for simultaneously acquired three slices. Self-LR shows a lower noise level, a more similar dynamic curve, and ×20 faster computation time than slice L+S. This is a comparison of slice-GRAPPA, slice-L+S, and slice-Self-LR for the reconstruction of MB-3 and R-3 with 1.5-millimeters×1.5-millimeters resolutions and nine slices dataset prospectively acquired from the patient.

Referring now to FIG. 12, there are nine slices reconstruction of MB=3 and R=3 with 1.5 millimeters×1.5 millimeters resolution, which shows good image quality and SNR for all slices. This self-supervised regularization loss is formulated under the assumption that outputs of Siamese subnetworks for a single image with similar undersampling masks are equal, enabling training with all available data. The Self-LR provides an efficient reconstruction of in-plane accelerated high spatiotemporal resolution MRI, striving to push the boundaries of spatiotemporal fidelity.

This simultaneous multiline (SMS) provides a unique strategy to improve slice coverage with reduced signal-to-noise ratio penalty and efficient MRI sequence design; it poses new problems for Self-LR design with an additional slice dimension and slice leakage artifacts. A Slice-Self-LR can reconstruct multiple slices and achieve a high spatial resolution of MRI with whole-heart coverage. This is a physics-guided self-supervised Siamese network configuration, which is a fundamentally new construct that provides myocardial MRI with a high spatial resolution (˜1.0 millimeters) and whole-heart coverage without the need for fully-sampled data as a reference. This technology would supply unprecedented sensitivity to uncover subtle, momentary signal changes that could reveal critical information in ischemic heart disease.

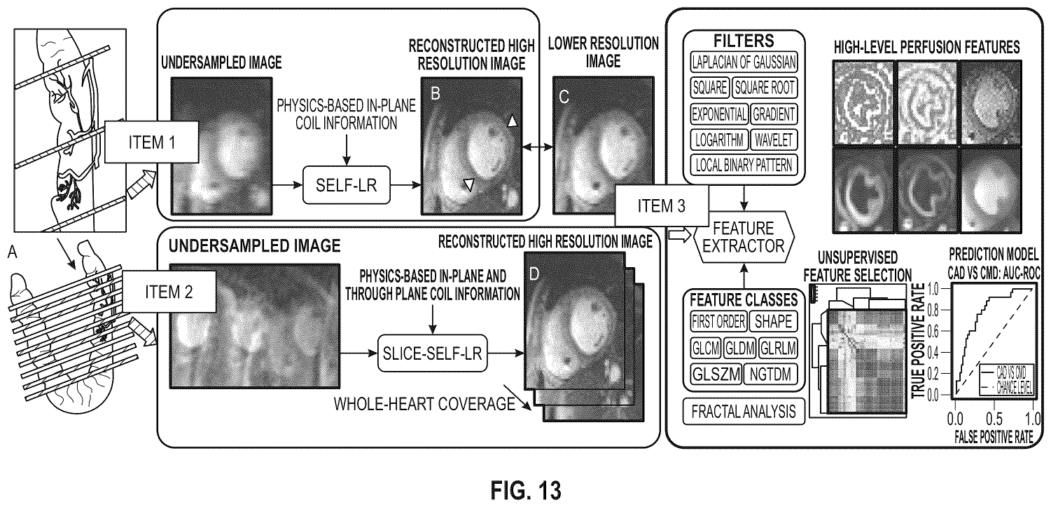

This is a dynamic contrast-enhanced magnetic resonance imaging (MRI) that enables noninvasive and non-ionizing radiation assessment of myocardial ischemia. Although visual analysis of myocardial MRI with vasodilator stress has been demonstrated to have a high sensitivity and specificity in detecting coronary artery disease (CAD), angina also exists in many patients with coronary microvascular disease (CMD) in the absence of significant obstructive CAD. Currently, CMD characterization requires the exclusion of obstructive CAD, followed by invasive evaluation through catheter-based measures. Quantitative MRI analysis may have prognostic advantages but requires rest and stress images, as well as arterial input function (AIF) images, which can take up to sixty minutes. Additionally, accurately measuring AIF is challenging with MRI, resulting in biased measurements of myocardial blood flow (MBF) and/or myocardial reserve (MPR). The recent CMR protocol, designed to take thirty minutes or less, increases patient access to CMR by acquiring stress first, followed by cine and late gadolinium enhancement imaging; however, it has a significant drawback of potentially limiting the detection of CMD. This self-supervised learning and machine learning (ML)-framework is, shown in FIG. 13, improves the characterization of ischemic diseases in a rapid 30-minute protocol, utilizing only stress MRI.

Referring again to FIG. 13, a conceptual framework with simulated images based on a clinical cardiac MRI is shown. Self-supervised learning with self-supervised Regularization (Self-LR) framework in Item 1 will enable accurate detection of detailed ischemic defects, and potentially transmural patterns for diagnosis of microvascular dysfunction (gray vessels in A) by high-resolution CMR (B vs C). Slice-Self-LR in Item 2 will achieve whole-heart coverage and complete assessment of myocardial ischemia (D).

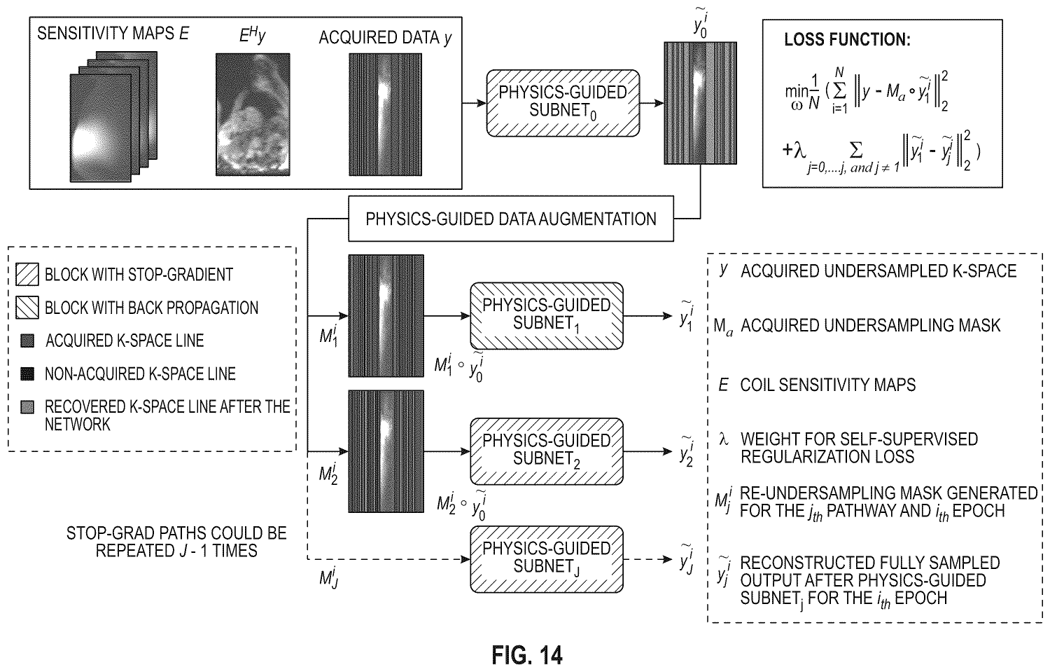

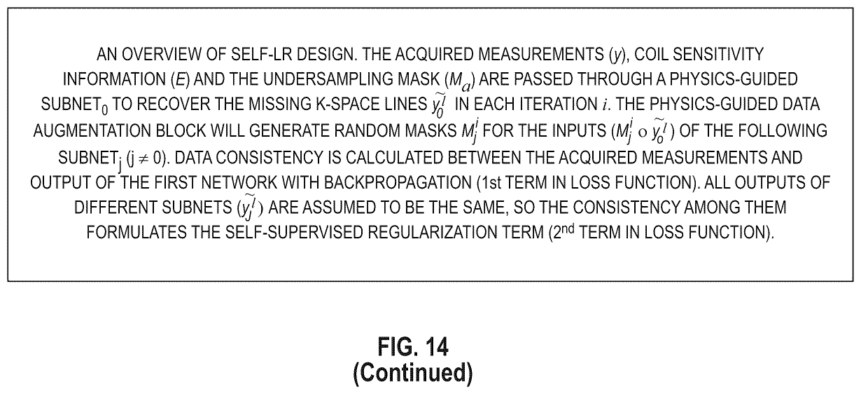

Most image acceleration techniques have an intrinsic tradeoff among spatial resolution, temporal resolution, slice coverage, and signal-to-noise ratio (SNR). The initial acceleration technique, parallel imaging, takes advantage of variations in the spatial sensitivity profiles of coil elements to reduce the number of phase-encoding steps. Parallel imaging, such as GRAPPA (GeneRalized Autocalibrating Partial Parallel Acquisition), acquires every other k-space line (rate-2 undersampling) and is routinely used in clinical practice. GRAPPA at a rate-2 acceleration is regarded as the reference standard. Although highly accelerated MRI is critical for further improving spatial resolution and slice coverage, highly accelerated imaging (>3) using parallel imaging is limited by noise enhancement. Compressed sensing is another acceleration technique that exploits the assumption of spatiotemporal sparsity and low rank of signal distribution; however, the use of k-t undersampling acquisition strategies and compressed sensing reconstruction may result in low fidelity and missed patterns, and the reconstruction time of the iterative compressed sensing algorithm is too long to inline reconstruct images. This deep learning-based method is shown in FIG. 14 and addresses the limitations of current acceleration techniques in MRI, such as noise enhancement, remaining artifacts, and low spatiotemporal fidelity, by training the model to understand the complex signals without the need for fully sampled data. This approach produces high-resolution images with improved fidelity, elevated SNR, and an efficient reconstruction.

Therefore, supervised deep neural networks, requiring a large amount of fully sampled data as the reference for reconstructing non-contrast images, have demonstrated outstanding potential for efficient MRI reconstruction with significantly high fidelity.

Furthermore, prior art physics-guided unrolled networks, which leverage the MR physics coil information and MRI constraint reconstruction models, have proven to be effective by transforming the iterative reconstruction algorithm into a series of network blocks. While these networks typically require a relatively smaller amount of fully sampled data for training and have been shown to have superior reconstruction performance compared with purely data-driven networks, it is impossible to obtain fully sampled data in myocardial MRI because of the clinical requirement for high spatiotemporal resolution during heart beating and circulation of contrast. While feasible, the physics-guided self-supervised learning approach of dividing undersampled measurements into two parts using pre-generated masks, one for network training and the other for a loss function to penalize incorrect estimations, may not be the optimal solution for MRI reconstruction because only a portion of the data is utilized in the loss function. The use of varying image sizes and asymmetric echoes in myocardial MRI can also present a challenge to the network's flexibility because of the need for matching to pre-generated undersampling masks of a fixed size. With the current approach, the reconstruction of myocardial MRI images of varying sizes may be hindered because of the lack of flexibility. This novel approach, incorporating a Siamese network and multiple physics-guided subnetworks, is expected to provide improved performance, robustness, and flexibility for myocardial MRI reconstruction.

One major limitation of prior art myocardial MRI is the limited spatial coverage of the ventricle with only three axial slices. To overcome this challenge, simultaneous multislice or multiband (MB) to acquire signals from multiple slices simultaneously can be utilized. The multiband method benefits from a low SNR penalty because of a better geometry factor and no reduction factor in acquisition. Our previous method combines the in-plane and through-plane coil information with the temporal low-rank and sparse (L+S) regularization, which is widely regarded as one of the best-predetermined regularization techniques. Despite promising results, this prior art approach still suffered from decreased image quality in terms of spatiotemporal fidelity and SNR, as well as a long reconstruction time that exceeded one hour. The current disclosure is a physics-guided, self-supervised learning approach, see FIG. 13, with the goal of significantly reducing the reconstruction times (speed-up of thirty to fifty times) and, at the same time, maintaining both spatiotemporal fidelity and SNR. Image reconstruction, including artifact removal, denoising, resolution enhancement, or other benefits for improving image quality from a rapid MRI acquisition, which means using fewer time, but getting similar images with original fully-sampled images. Rapid MRI means accelerating and reconstructing MRI images for any MRI sequences. Myocardial perfusion MRI is merely one illustrative example application for this technique.

Therefore, Self-LR outperformed ESPIRiT and L+S methods and is a promising method for improving spatiotemporal fidelity of the reconstruction of undersampled MRI without fully-sampled k-space.

This is a physics-guided (PG) self-supervised learning (SSL) method with self-supervised Regularization (Self-LR) using a Siamese structure for utilizing all the acquired k-space data in both data consistency block and calculation of loss function. To overcome the challenges of noise enhancement and collapsing, this Self-LR method was invented with a stop-gradient, a Physics-guided data augmentation network block, and consistency of sub-Physics-guided networks. The Self-LR method is applied to imaging for single-band (SB) and multiband (MB) acceleration.

Another embodiment of the present invention is a self-supervised learning method, self-supervised Learning with self-supervised Regularization (self-LR), which may improve image quality in high-resolution MRI, especially for asymmetric echo data, as it does not virtually split data along the readout dimension. A highly accelerated first-pass MRI sequence was modified with asymmetric echo and varied image sizes, free-breathing rest data were acquired on fifteen patients, and self-LR was compared to other methods.

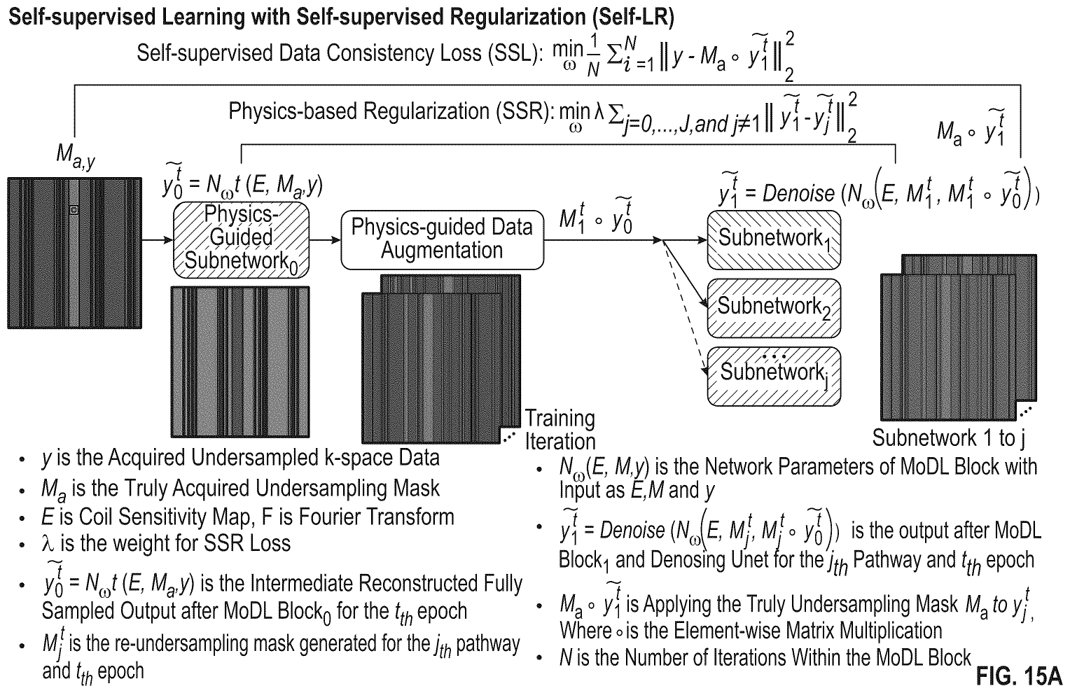

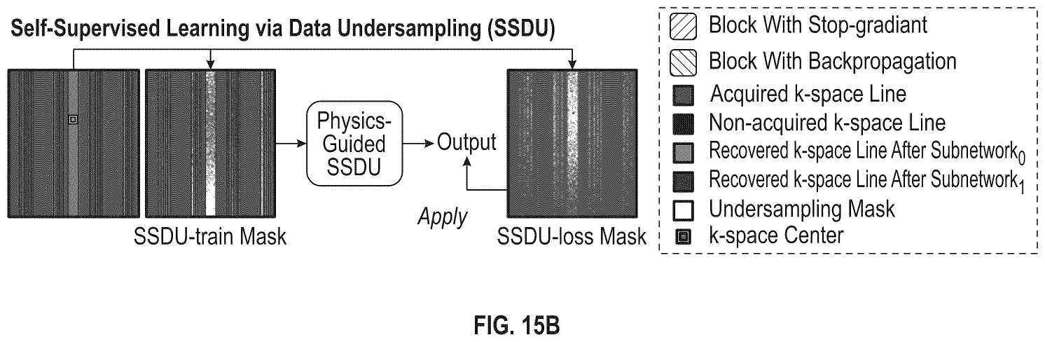

Fifteen datasets (7350 multicoil k-space) on a 1.5T scanner were collected, i.e., SIEMENS® Aera™, using a modified saturation-recovery gradient-echo sequence with asymmetric echo and Poisson disc undersampling. The undersampling resulted in about eighteen centrally located fully sampled lines, with an effective undersampling rate of over 11-fold applied to regions outside the center, as shown in FIGS. 15A and B. Self-LR was implemented in PyTorch using stop-gradient and a combination of normalized and loss for both self-supervised data loss and self-regularization loss. Prospective datasets were reconstructed using both SSDU and self-LR and scored by a cardiologist and a radiologist based on SNR, sharpness, artifacts, and overall image quality. Please keep in mind that SSDU is a prior art methodology that is believed to have bias and is not a component of this invention.

Referring to FIG. 15A, the schematic diagram of self-LR for highly accelerated data (11.4-fold) is designed using a Siamese network structure with a physics-guided data augmentation block and consistency of subnetworks. This design enables all acquired data to be used in the loss and data consistency blocks, eliminating the need for data splitting shown in FIG. 15B, whereas SSDU requires data splitting along the readout dimension. The prospectively acquired data, obtained with clinically used asymmetric echo and varied data matrix size, may not be optimal for data splitting. The image sizes of the fifteen datasets range from 256-264×200-246. As previously stated, SSDU is a competitive technology only shown for contrast and not part of the current invention. The fifteen datasets were divided into two groups: Ten datasets were designated for training the model, and the remaining five datasets were reserved for model inference. Each dataset was acquired with 7-8 slices and seventy measurements. For each epoch, one measurement is randomly selected from a set of seven successive measurements in each dataset. The learning rate of SSDU was compared between 5e-5 and 5e-4, and 5e-5, which showed fewer artifacts, was used for 100 epochs. The learning rate of self-LR was set at 1e-4 for 200 epochs. Three subnets were used in self-LR training, but only the first subnet was used in inference.

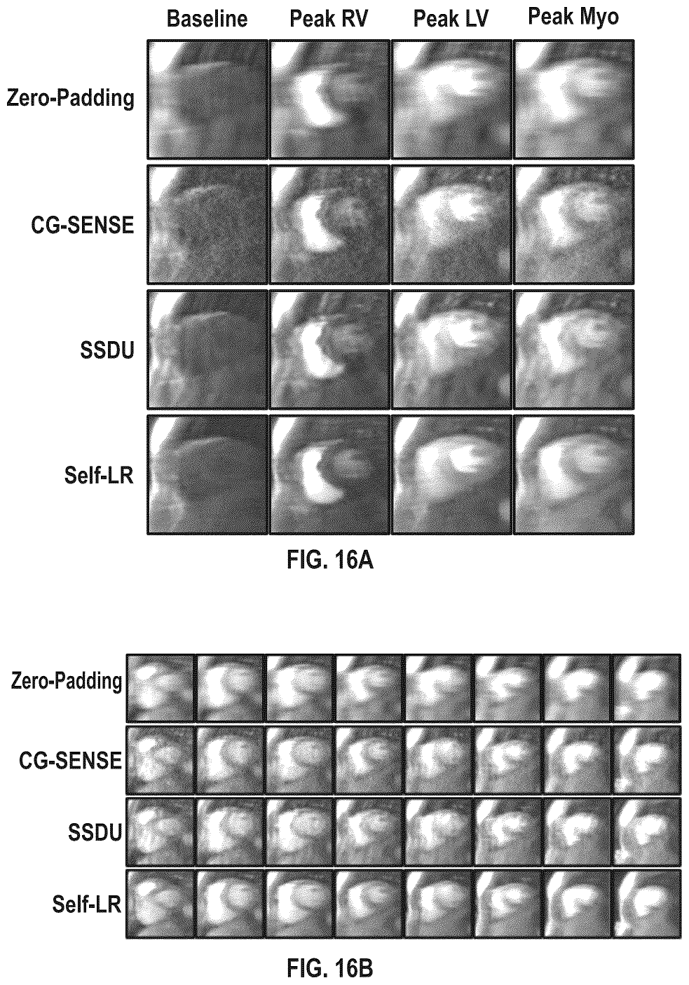

FIGS. 16A and 16B compare images reconstructed using zero-padding, CG-SENSE, SSDU, and self-LR at various contrast phases and slice locations. Self-LR consistently outperforms other methods, producing images with higher SNR, fewer artifacts, and better overall quality across all measurements and locations. FIG. 16A is a comparison of zero-padding, CG-SENSE, SSDU, and self-LR methods in the reconstruction of prospectively undersampled MB first-pass MRI (R=11.4) with a spatial resolution of 1.5 millimeters×1.5 millimeters, temporal resolution of 95 ms, and 8-slice coverage of the left ventricle. FIG. 16B is a comparison of all acquired slices using zero-padding, CG-SENSE, SSDU, and self-LR for the reconstruction of prospectively undersampled first-pass MRI. Overall, the self-LR method produced images with the fewest residual artifacts, the highest SNR, and superior overall image quality compared to the other methods. LV, left ventricle; Myo, myocardium; RV, right ventricle.

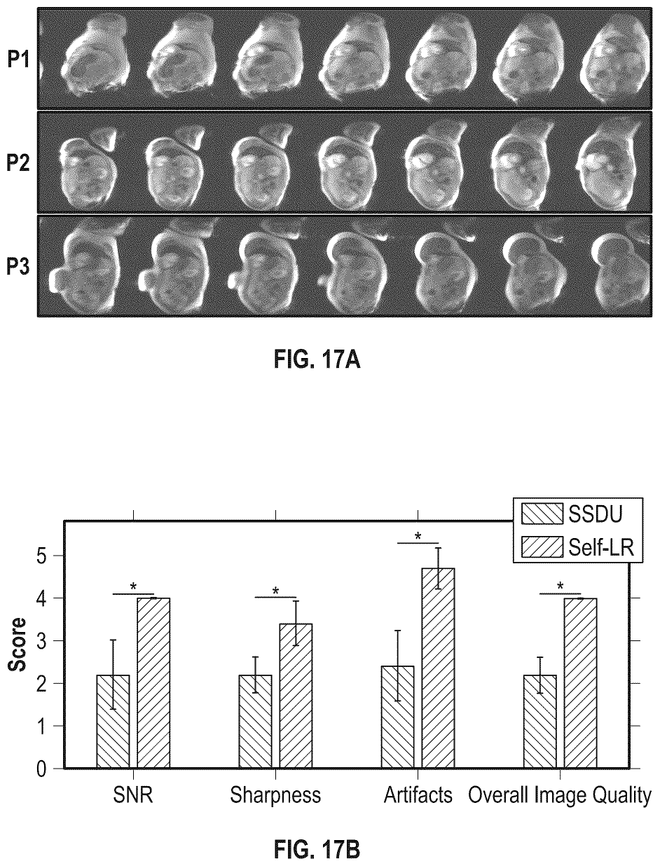

FIG. 17A shows three additional patient examples from the test datasets, illustrating the performance of self-LR reconstruction across the entire field of view for all seven slices at a single measurement. This superiority is further confirmed by reader evaluations, which indicate significantly better self-LR performance over SSDU in signal-to-noise ratio (SNR), sharpness, artifacts, and overall image quality. FIG. 17B is a Wilcoxon signed rank test was employed for statistical analysis, with an asterisk (*) indicating a significant difference at p>0.05. Across all metrics, including SNR, sharpness, aliasing artifacts, and overall image quality, self-LR demonstrated superior performance compared to SSDU for reconstruction of the prospectively acquired data. As previously stated, SSDU is a competitive technology only shown for contrast and not part of the current invention.

Consequently, the results, achieved with over eleven-fold accelerated high-resolution MRI using self-LR, provide a promising and efficient approach for reconstructing free-breathing MRI. The self-LR method potentially enables inline reconstruction of all measurements, thereby improving spatiotemporal resolution and slice coverage while maintaining spatiotemporal fidelity and high reconstruction speed. Further testing at lower acceleration rates is ongoing.

The proposed Self-LR outperformed ESPIRiT and L+S methods in SB reconstruction, shows high computational efficiency for MB reconstruction, and is a promising method for improving spatiotemporal fidelity, slice coverage, and spatial resolution of highly accelerated MRI without fully sampled k-space.

From the foregoing, it can be seen that the present disclosure accomplishes at least all of the stated objectives.

### LIST OF REFERENCE CHARACTERS

The following table of reference characters and descriptors are not exhaustive, nor limiting, and include reasonable equivalents. If possible, elements identified by a reference character below and/or those elements which are near ubiquitous within the art can replace or supplement any element identified by another reference character.

TABLE 1
List of Reference Characters

| | |
|---|---|
| 10 | MRI imaging system |
| 20 | Platform |
| 30 | Control unit |
| 32 | Processor |
| 34 | Memory |
| 50 | Schematic diagram of the proposed self-supervised learning |
| | with self-supervised regularization model (Self-LR) |
| 51 | Coil sensitivity maps and an undersampling mask based on the |
| | acquired and undersampled two-dimensional k-space data |
| 52 | Coil sensitivity maps and an undersampling mask based on the |
| | acquired and understampled two-dimensional k-space data is |
| | utilized to generate intermediate fully sampled k-space (MoDL |
| | Block₁.) |
| 54 | The output image of the first (MoDL) block is utilized to |
| | create a model-based reconstruction using deep leaned priors |
| | (MoDL) (model-based deep learning architecture) block. |
| 56 | Re-undersampling block |
| 58 | Reconstruct re-unsampled k-space (MoDL Block₂) |
| 60 | Denoise Block (Unet) |
| 62 | First iteration |
| 64 | Second iteration |
| 66 | i^{th} iteration |
| 68 | N^{th} iteration |
| 70 | ResNet |
| 72 | Data consistency |
| 74 | Intermediate multicoil k-space |
| 76 | Random undersampling |
| 78 | Coil combined image |
| 80 | Single-band and multiband data reconstruction |
| 82 | Multiband loss function |

### Glossary

Unless defined otherwise, all technical and scientific terms used above have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

As used herein, the term “exemplary” refers to an example, an instance, or an illustration, and does not indicate a most preferred embodiment unless otherwise stated.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variables, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “invention” is not intended to refer to any single embodiment of the particular invention but encompass all possible embodiments as described in the specification and the claims. The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

What is claimed is:

1. A system to process images to improve the quality of MRI images, comprising:
an MRI;
a processor; and
a memory, enabled to store data in electronic communication with the processor, wherein the memory is able to receive image data of a dynamic scene from the first-pass MRI, and the processor is able to utilize a Self-LR model based on a physics-guided Siamese network structure utilizing an encoding matrix with coil sensitivity maps and an undersampling mask that is converted to an intermediate fully sampled model deep learning that is then passed into a re-undersampling process and then reconstructed into unsampled k-space through a second model deep learning process.

2. The system to process images to improve the quality of MRI images according to claim 1, further comprising a denoise block to control noise from undersampling with Unet operating on the unsampled k-space through a second model deep learning process.

3. The system to process images to improve the quality of MRI images according to claim 1, further comprising both a stop-gradient and an additional Unet.

4. The system to process images to improve the quality of MRI images according to claim 1, wherein the process utilizes deep learning priors.

5. The system to process images, that are single band and/or multiband, to improve the quality of MRI images according to claim 4, wherein the deep learning priors include a physics-guided network that uses a ResNet structure with a predetermined number of residual blocks and is unrolled for a predetermined number of iterations.

6. The system to process images to improve the quality of MRI images according to claim 1, wherein the re-undersampling includes an intermediate multicoil k-space followed by random undersampling followed by generating a coil combined image.

7. The system to process images to improve the quality of MRI images according to claim 1, wherein the intermediate fully sampled model deep learning includes a series of iterations, each including ResNet for deep residual learning for image reconstruction followed by data consistency analysis.

8. A system to process images, for single band and/or multiband acceleration, to improve the quality of MRI images, comprising:
an MRI;
a processor; and
a memory, enabled to store data in electronic communication with the processor, wherein the memory is able to receive image data of a dynamic scene from the MRI, and the processor is able to utilize a Self-LR model based on a physics-guided Siamese network structure utilizing an encoding matrix with coil sensitivity maps and an undersampling mask that is converted to a first model deep learning block that communicates with a physics guided data augmentation followed by a re-undersampling block and then to a plurality of physics guided subnets.

9. The system to process images, for single band and/or multiband acceleration, to improve the quality of MRI images according to claim 8, wherein the first model deep learning block includes a stop-gradient.

10. The system to process images, for single band and/or multiband acceleration, to improve the quality of MRI images according to claim 8, wherein the plurality of physics-guided subnets includes one block with backpropagation and the remainder of physics-guided subnets include a stop-gradient with shared weights with only one subnet updating weights during backpropagation and the other subnets using stop-gradient to prevent collapsing.

11. The system to process images, for single band and/or multiband acceleration, to improve the quality of MRI images according to claim 10, wherein the physics-guided subnet that includes one block with backpropagation includes a second model deep learning block connected to a denoise block.

12. The system to process images, for single band and/or multiband acceleration, to improve the quality of MRI images according to claim 11, wherein the plurality of physics-guided subnets with stop gradient includes a third model deep learning block connected to a denoise block.

13. The system to process images, for single band and/or multiband acceleration, to improve the quality of MRI images according to claim 12, wherein the first model deep learning block, the second model deep learning block, and the third model deep learning block includes a series of iterations each including an unrolled network including data consistency block and a ResNet for deep residual learning for image reconstruction followed by data consistency analysis.

14. The system to process images, for single band and/or multiband acceleration, to improve the quality of MRI images according to claim 12, wherein the denoise block includes controlling noise from undersampling with Unet operating on the unsampled k-space through a model deep learning process.

15. The system to process images, for single band and/or multiband acceleration, to improve the quality of MRI images according to claim 8, wherein the re-undersampling includes an intermediate multicoil k-space followed by random undersampling that utilizes a design comparable to the original undersampling mask followed by generating a coil combined image.

16. The system to process images, for single band and/or multiband acceleration, to improve the quality of MRI images according to claim 8, wherein the Self-LR model provides a physics-guided Siamese network, which includes physics-guided data augmentation, and a physics-guided network consistency concept that is included in a loss function.

17. A method for processing images, that are single and/or multiband, to improve the quality of MRI images, comprising:
utilizing a processor in electronic communication with a memory, wherein the memory is able to receive image data of an image from an MRI; and
utilizing the processor with a Self-LR model based on a physics-guided Siamese network structure utilizing an encoding matrix with coil sensitivity maps and an undersampling mask that is converted to a first model deep learning block that communicates with a physics-guided data augmentation followed by a re-undersampling block and then to a plurality of physics guided subnets.

18. The method for processing images, that are single and/or multiband, to improve the quality of MRI images according to claim 17, wherein the plurality of physics-guided subnets includes one block with backpropagation and the remainder with stop-gradient with shared weights with only one subnet updating weights during backpropagation and the other subnets using stop-gradient to prevent collapsing.

19. The method for processing images, that are single and/or multiband, to improve the quality of MRI images according to claim 18, wherein the physics-guided subnet that includes one block with backpropagation includes a second model deep learning block connected to a denoise block and the plurality of physics guided subnets with stop gradient includes a third model deep learning block connected to a denoise block.

20. The method for processing images, that are single and/or multiband, to improve the quality of MRI images according to claim 19, wherein the first model deep learning block, the second model deep learning block, and the third model deep learning block includes a series of iterations each including ResNet for deep residual learning for image reconstruction followed by data consistency analysis.
